(19) United States
(12) Patent Application Publication
(10) Pub. No.: US 2026/0145187 A1
(43) Pub. Date: May 28, 2026

(54) BIPOLAR ELECTROSTATIC DEPOSITION (BED) WITH CYCLONE AND VORTEX FLOW

(71) Applicant: Soelect Inc., Greensboro, NC (US)

(72) Inventor: Sungjin CHO, Summerfield, NC (US)

(21) Appl. No.: 19/399,045

(22) Filed: Nov. 24, 2025

Related U.S. Application Data
(60) Provisional application No. 63/724,058, filed on Nov. 22, 2024.

(51) Int. Cl. B05B 5/14; B05C 9/12; H01M 4/04

(52) U.S. Cl. CPC B05B 5/14; B05C 9/12; H01M 4/0404; H01M 4/0419; H01M 4/0435

(57) ABSTRACT

The present disclosure provides a bipolar electrostatic deposition system comprising a deposition chamber configured to enclose a substrate transport path, an electrostatic generator configured to apply a controlled electrical potential to a conductive substrate, a powder supply unit configured to supply powder into the deposition chamber, at least one impeller device and at least one gas nozzle positioned within the deposition chamber and configured to generate rotational flow patterns that suspend and circulate the powder throughout the deposition chamber, and wherein the electrostatic generator charges the conductive substrate to create an electric field that electrostatically attracts the powder in the deposition chamber to the conductive substrate.

### CROSS-REFERENCE TO RELATED APPLICATIONS

This application claims priority to U.S. Provisional Ser. No. 63/724,058, filed Nov. 22, 2024, which is hereby incorporated by reference in its entirety.

### TECHNICAL FIELD

The present disclosure relates to electrostatic powder deposition systems for forming dry particulate coatings on electrically conductive substrates, and more particularly to a bipolar electrostatic deposition process that combines substrate charging and particle charging with controlled cyclone and vortex gas flow in a closed chamber to form high density and high loading electrodes for use in batteries.

### BACKGROUND

Electrostatic powder deposition, also referred to as electrostatic spray deposition or powder coating, is widely used to apply layers of powder onto electrically conductive surfaces. In conventional processes, powder particles are charged through corona discharge or triboelectric charging and then directed toward a grounded metal substrate. The electrostatic field attracts the charged particles so that they deposit on the surface and form a layer that can be melted, sintered, or otherwise consolidated.

Although effective for relatively thin coatings, conventional electrostatic deposition approaches have several limitations when applied to high density, high loading, or thick particulate layers. It can be difficult to uniformly charge particles that exhibit broad distributions in size, shape, morphology, and surface chemistry. Smaller particles have a large specific surface area and demand more energy and time to achieve uniform electrostatic charge, often leading to non-uniform charging of the powder cloud and local variations in deposition rate.

As charged powder accumulates on the metal substrate, the deposited layer itself becomes charged and starts to shield the underlying electric field. The field near the surface weakens and the charged layer repels additional incoming particles. This field shielding limits the maximum achievable coating thickness and makes multi-layer build up difficult without sacrificing uniformity or adhesion.

Many electrochemical applications, such as lithium metal anodes and dry cathodes for advanced batteries, require high mass loading and compact packing of active particles while maintaining strong mechanical bonding between the active material and the current collector. Conventional wet slurry coating methods depend on polymer binders and solvents, followed by drying and calendaring. Once these steps are completed, structural parameters such as porosity, tortuosity, and density are largely fixed, leaving limited freedom for further optimization.

Conventional dry electrostatic spray techniques also struggle to control mass loading and powder packing density while maintaining uniformity across the entire substrate. For lithium metal anodes, additional challenges arise from non-uniform surface reactions and dendrite formation. Irregular or inhomogeneous powder layers and surface treatments can induce non-uniform current distribution and local side reactions, which accelerate lithium consumption, increase internal resistance, and shorten cell life. Similar concerns apply to dry cathodes where poor interface contact and non-uniform coating thickness degrade electrochemical performance and mechanical stability.

There exists a need for electrostatic deposition systems that can handle a wide range of particle sizes and morphologies, provide uniform coverage, support both thin and thick coatings, and improve bonding between particles and conductive substrates. There is also a need for processes that can reduce or eliminate reliance on liquid binders and solvents while achieving high packing density and controlled mass loading.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a bipolar electrostatic deposition system is provided. The system comprises a deposition chamber configured to enclose a substrate transport path. The system comprises an electrostatic generator configured to apply a controlled electrical potential to a conductive substrate. The system comprises a powder supply unit configured to supply powder into the deposition chamber. The system comprises at least one impeller and at least one gas nozzle positioned within the deposition chamber and configured to generate rotational flow patterns that suspend and circulate the powder throughout the deposition chamber. The electrostatic generator charges the conductive substrate to create an electric field that electrostatically attracts the powder in the deposition chamber to the conductive substrate.

According to other aspects of the present disclosure, the system may include one or more of the following features. The system may further comprise a venting system configured to collect unused powder and return the unused powder to a powder reservoir. The conductive substrate may comprise lithium metal foil, aluminum foil, copper foil, carbon coated foil, nickel foil, stainless steel foil, or graphene-based foil. The electrostatic generator may be configured to apply a positive potential, a grounded potential, alternating polarity, or sequential polarity switching to the conductive substrate. The electrostatic generator may provide approximately minus ten kilovolts with a controlled current level. The at least one impeller may include segmented blades configured to convert upward airflow into rotational motion that expands or contracts according to a direction of rotation. The rotational flow patterns may comprise cyclone-type flow along chamber walls or vortex-type flow toward a chamber center. The deposition chamber may be operable in a fully mixed mode that equalizes powder concentration throughout the deposition chamber. The deposition chamber may be operable in a selective coating mode where the rotational flow patterns concentrate the powder in localized regions of the conductive substrate. The system may further comprise at least one compacting roller positioned downstream of the deposition chamber and configured to compact and consolidate a deposited powder layer on the conductive substrate.

According to another aspect of the present disclosure, a method for forming a particulate coating on a conductive substrate is provided. The method comprises charging the conductive substrate to a selected electrical potential using an electrostatic generator. The method comprises introducing powder into a deposition chamber that encloses a substrate transport path. The method comprises generating rotational flow patterns within the deposition chamber using at least one impeller and at least one gas nozzle to suspend and circulate the powder throughout the deposition chamber. The method comprises creating an electric field by the charged conductive substrate that electrostatically attracts the powder in the deposition chamber to the conductive substrate to cause the powder to deposit on the conductive substrate.

According to other aspects of the present disclosure, the method may include one or more of the following features. The method may further comprise collecting unused powder and returning the unused powder to a powder reservoir using a venting system. The method may further comprise a two-stage deposition process including a first stage of depositing neutral powder onto the charged conductive substrate through induced dipole interactions, and a second stage of modifying the electrical potential of the conductive substrate and depositing electrostatically charged powder onto the substrate to increase packing density and fill voids in a previously formed coating layer. The step of charging the conductive substrate may comprise direct electrical contact charging, induction-based charging, or corona-based charging. The step of charging the conductive substrate may apply approximately minus ten kilovolts with a controlled current level. The rotational flow patterns may comprise cyclone-type flow along chamber walls or vortex-type flow toward a chamber center. The method may further comprise a step of repeating the introducing and creating steps under reversed substrate polarity or reversed particle polarity to increase packing density and fill voids in the coating. The step of generating rotational flow patterns may be dynamically altered during deposition to modulate coating distribution or coating thickness. The method may further comprise a step of compacting the coating using a compacting roller to consolidate the deposited powder and increase packing density.

According to another aspect of the present disclosure, a particulate coated electrode produced by a process is provided. The process comprises charging a conductive substrate to a selected electrical potential using an electrostatic generator. The process comprises introducing powder into a deposition chamber that encloses a substrate transport path. The process comprises generating rotational flow patterns within the deposition chamber using at least one impeller and at least one gas nozzle to suspend and circulate the powder throughout the deposition chamber. The process comprises creating an electric field by the charged conductive substrate that electrostatically attracts the powder in the deposition chamber to the conductive substrate to cause the powder to deposit on the conductive substrate. The process comprises compacting the deposited powder to achieve controlled density and thickness.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a schematic diagram of a bipolar electrostatic deposition system, according to aspects of the present disclosure.

FIG. 2 presents a front view of the bipolar electrostatic deposition system, according to an embodiment.

FIG. 3 illustrates a top view of the bipolar electrostatic deposition system of FIG. 2, according to aspects of the present disclosure.

FIG. 4 provides a side elevation view of the bipolar electrostatic deposition system of FIG. 2, according to an embodiment.

FIG. 5 depicts a standard electrostatic deposition system.

FIG. 6 depicts the dual sequencing BED system according to an embodiment.

FIG. 7 illustrates an internal side view of a deposition chamber with a uniformly powdered substrate, according to aspects of the present disclosure.

FIG. 8 illustrates a high loading cathode layer formed on a conductive substrate, according to an embodiment.

FIG. 9 presents deposition images showing selective and localized deposition on a substrate, according to aspects of the present disclosure.

FIG. 10 illustrates an internal view of the deposition chamber showing cyclone and vortex flow components, according to an embodiment.

FIG. 11 depicts a flowchart showing a process for forming a particulate coating on a conductive substrate using bipolar electrostatic deposition, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a bipolar electrostatic deposition system and method for forming dry particulate coatings on electrically conductive substrates. The system may be configured to deposit powder materials onto substrates such as lithium metal foil, aluminum foil, copper foil, and other current collectors used in battery electrode applications. In some cases, the bipolar electrostatic deposition process combines controlled substrate charging with particle charging under a bipolar electric field environment to achieve enhanced powder adhesion and uniform coating distribution. In some embodiments, the powdered materials and/or particles may include metal powders, oxides, sulfides, phosphates, carbides, carbon materials, lithium salts, solid state electrolytes such as Garnet, NASICON, Sulfide, Oxide Perovskite, Glass Ceramic LISICON, LIPO, nitrogen-based additives, hydrophilic functionalized particles, or combinations thereof. The particulate materials may be selected to modify functional properties including ionic conductivity, lithium diffusion coefficient, surface morphology, surface roughness, electrical conductivity, interfacial resistance, or combinations of these properties. As used herein, a ‘bipolar electric field’ refers to an electric field established by a charged conductive substrate and surrounding structures that induces bipolar (dipole) charge distributions in nearby powder particles and may be operated with either positive or neutral/grounded substrate polarity.

In some embodiments, the bipolar electrostatic deposition approach may differ from conventional electrostatic powder coating methods by implementing a two-stage charging process. In some cases, a conductive substrate may first be charged to a controlled potential while neutral particulate materials are introduced into a closed deposition chamber. The charged substrate may polarize the neutral particles through induced dipole interactions, causing the particles to be attracted uniformly across the substrate surface. In some cases, the substrate potential and particle charging conditions may be adjusted in a subsequent stage (e.g., a grounded substrate) so that electrostatically charged particles are deposited onto a previously formed layer, which may increase packing density and fill voids in the coating. The powder particles may have sizes ranging from one nanometer to one millimeter, allowing the bipolar electrostatic deposition system to accommodate a wide variety of particulate materials with different morphologies and surface characteristics.

The deposition chamber may incorporate cyclone and/or vortex gas flow patterns generated by impeller devices (e.g., fan units) to maintain powder particles in a suspended state throughout the chamber volume. In some cases, the controlled gas flow may create a fully mixed powder environment that enables uniform coating across the entire substrate surface. The system may also be operated in a focused flow mode where cyclone and/or vortex patterns are modulated to direct powder toward specific regions of the substrate, allowing for selective localized deposition.

A closed recirculation loop may be incorporated in the disclosed BED system to capture unused powder through a venting and evacuation unit and return the powder to a powder chamber. This recirculation system may reduce powder loss and stabilize process conditions during extended coating operations. In some cases, the bipolar electrostatic deposition system may support a broad range of particle sizes and coating thicknesses, from thin seed layers to thick high-loading electrodes suitable for advanced battery applications.

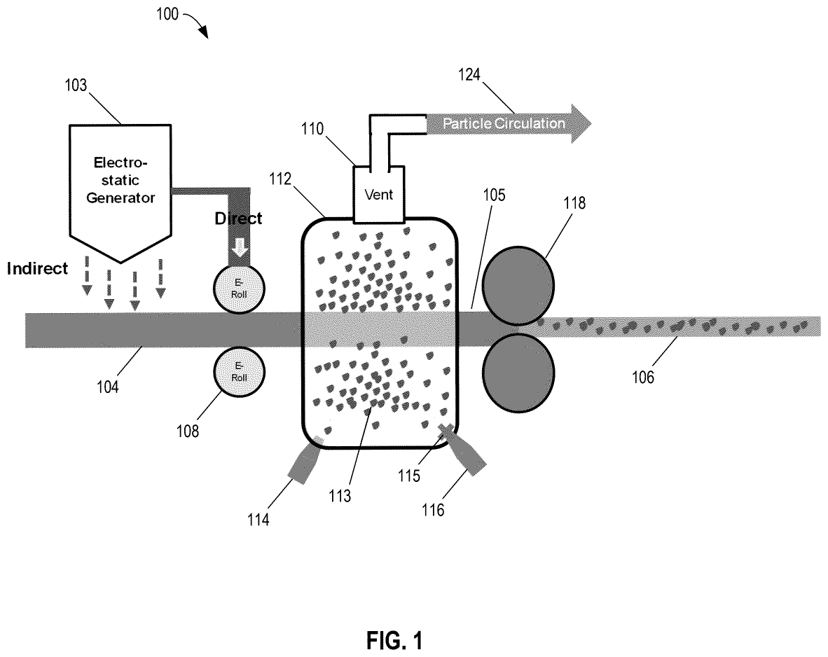

Referring to FIG. 1, an exemplary bipolar electrostatic deposition system 100 may include several components that function together to achieve controlled powder deposition on conductive substrates. The bipolar electrostatic deposition system 100 may comprise an electrostatic generator 103, a deposition chamber 112, a venting system 110, and various components for substrate transport and powder handling.

A substrate 104 may enter the bipolar electrostatic deposition system 100 and pass through (or over) one or more electrostatic rollers 108, which may apply a controlled electrical potential to the substrate surface. Notably, the electrostatic generator 103 may provide electrical power for directly charging the substrate 104 through the electrostatic roller(s) 108. In some cases, the substrate 104 may comprise lithium metal foil, aluminum foil, copper foil, or other conductive current collectors used in battery electrode applications. In some embodiments, electrostatic generator 103 may indirectly charge substrate 104 by generating an electrostatic field that is applied to the surface of the substrate 104.

After charging either directly or indirectly, the substrate 104 may enter the deposition chamber 112, where powder particles 113 are introduced (e.g., dry sprayed via a powder supply unit 114. The powder particles 113 may have sizes ranging from one nanometer to one millimeter, allowing the bipolar electrostatic deposition system 100 to accommodate a wide variety of particulate materials. In some cases, the powder particles 113 may include metal powders, oxides, sulfides, phosphates, carbides, carbon materials, lithium salts, solid state electrolytes, nitrogen-based additives, or hydrophilic functionalized particles.

Within the deposition chamber 112, one or more impellers 115 and one or more gas nozzles 116 may operate together to generate controlled airflow patterns that suspend and circulate the powder particles 113 throughout the chamber volume. The impeller 115 may convert upward or angled airflow from the gas nozzle 116 into rotational motion, creating either a cyclone-type flow along the chamber walls and/or a vortex-type flow toward the chamber center. This flow pattern may maintain the powder particles 113 in a suspended state and promote uniform distribution within the deposition chamber 112. In some embodiments, the cyclone or vortex flow in the chamber can be implemented via the number of impellers used, the impeller shape, the configuration of the impeller blades (e.g., angled in an up, down, or horizontal alignment), impeller direction, and impeller speed.

As the substrate 104 passes through the deposition chamber 112, the powder particles 113 may be attracted to and deposit on the substrate surface due to electrostatic forces, forming a powdered substrate 105. The bipolar electrostatic field within the deposition chamber 112 may polarize the powder particles 113 through induced dipole interactions, thereby enhancing adhesion to the substrate surface. In some cases, auxiliary field shaping electrodes may surround the deposition chamber 112 to modulate the polarity and spatial distribution of the electric field, thus providing additional control over the deposition process.

Unused powder particles that remain airborne may be collected by the venting system 110 located at an upper portion of the deposition chamber 112. The venting system 110 may capture these recirculated powder particles 124 and return the recirculated powder particles 124 to a powder supply chamber (not shown) for reuse, creating a closed-loop recirculation system that may minimize powder waste.

After deposition and exiting chamber 112, the powdered substrate 105 may pass through a pair of compacting and/or smoothing rollers 118, which may compact and consolidate the deposited powder layer to form a compacted and/or smoothed substrate 106. The compacting rollers 118 may adjust thickness and increase packing density of the coating layer, producing a uniform and mechanically stable electrode structure. In some embodiments, a single compacting and/or smoothing roller may be used to compact or smooth substrate 106.

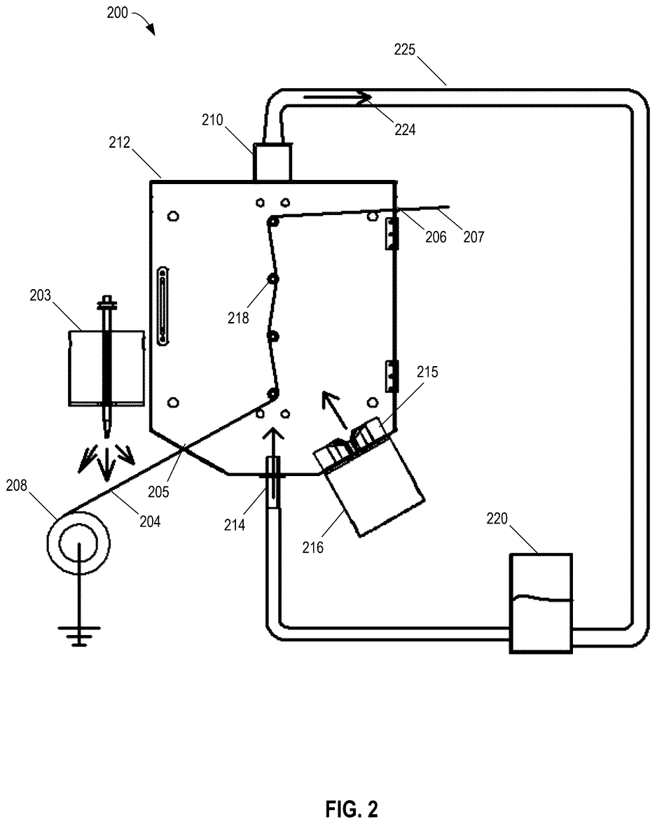

Referring to FIG. 2, a bipolar electrostatic deposition system 200 may be configured to provide a front view perspective of a powder coating apparatus. The bipolar electrostatic deposition system 200 may demonstrate how various components are arranged to facilitate controlled deposition of particulate materials onto conductive substrates.

In some embodiments, a substrate 204 (i.e., a metallic substrate foil or web) may enter the bipolar electrostatic deposition system 200 through a substrate inlet 205 positioned at a lower left portion of the apparatus. The substrate 204 may comprise various conductive materials suitable for battery electrode applications. In some cases, the substrate 204 may be lithium metal foil for anode applications, aluminum foil for cathode applications, copper foil, carbon coated foil, nickel foil, stainless steel foil, or graphene-based foil, depending on the specific electrode requirements.

Prior to entry through the substrate inlet 205, the substrate 204 may pass over a grounded roller 208, which may stabilize or neutralize the electrical potential of the substrate 204 and remove any residual charge prior to electrostatic conditioning. The grounded roller 208 may provide a controlled electrical reference point that prepares the substrate 204 for subsequent charging operations.

An electrostatic generator 203 may be positioned above or proximate to substrate 204 and may apply a controlled electrical potential to the surface of the substrate 204. The electrostatic generator 203 may prepare the substrate 204 for enhanced powder attraction within a deposition chamber 212 by generating and/or establishing a predetermined electric field condition on the substrate surface.

The substrate 204 may then travel into and through the deposition chamber 212, which may maintain powder particles in a suspended state through controlled gas flow patterns. The deposition chamber 212 may incorporate one or more impeller devices 215 and at least one gas nozzle 216 arranged near a lower region of the chamber. The gas nozzle 216 may introduce gas flow (e.g., forced dry air or argon gas) into the deposition chamber 212, while the impeller device 215 may generate rotational flow patterns that suspend and circulate powder particles throughout the chamber volume.

A powder supply unit 214 may inject or deliver powder into the deposition chamber 212 from a powder chamber 220 located at a lower right portion of the bipolar electrostatic deposition system 200. The powder chamber 220 may serve as both a supply reservoir for fresh powder and a receiving vessel for recirculated powder materials.

As the substrate 204 passes through the deposition chamber 212, powder particles may adhere to the substrate surface, forming a powdered substrate 207. In some embodiments, one or more chamber rollers 218 may be positioned within the deposition chamber 212 to guide the substrate 204 along a defined transport path during the coating process.

A venting system 210 may be installed at an upper portion of the deposition chamber 212 and may extract airborne powder particles that have not deposited on the substrate 204. The venting system 210 may direct recirculated powder particles 224 through a recirculation loop 225 back to the powder chamber 220. The recirculation loop 225 may create a closed-loop powder management system that may minimize material waste and maintain consistent powder concentration during extended coating operations.

In some embodiments, the powdered substrate 207 may exit the bipolar electrostatic deposition system 200 through a substrate outlet 206 positioned at an upper right portion of the apparatus, where the coated substrate may undergo subsequent processing steps. The front view arrangement of FIG. 2 may illustrate the vertical relationship between the substrate inlet 205, the grounded substrate 204, the electrostatic generator 203, the deposition chamber 212, the venting system 210, and the substrate outlet 206, demonstrating the complete functional layout of the bipolar electrostatic deposition system 200.

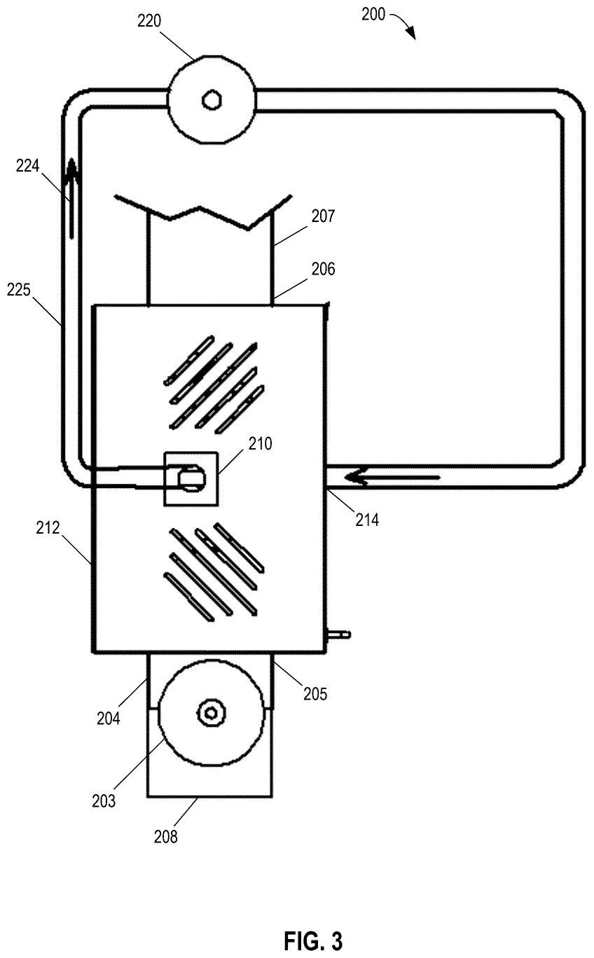

FIG. 3 may illustrate a top view perspective of a bipolar electrostatic deposition system 200 showing the planar arrangement of substrate transport components, powder delivery systems, and recirculation pathways. The bipolar electrostatic deposition system 200 may demonstrate the horizontal spatial relationships among the various functional elements that enable controlled powder deposition onto conductive substrates.

The substrate 204 may enter the deposition chamber 212 of bipolar electrostatic deposition system 200 through the substrate inlet 205 located at a lower portion of the apparatus. The substrate 204 may travel along a defined transport path through the deposition chamber 212, which may occupy a central region of the bipolar electrostatic deposition system 300. The planar view of FIG. 3 reveals how the substrate 204 moves from the substrate inlet 205 to the substrate outlet 206, passing through the powder-laden environment within the deposition chamber 212.

Within the deposition chamber 212, powder may be introduced through a powder supply unit 214, which may deliver particulate materials into the chamber environment from the powder chamber 220. The electrostatic generator 203 may be positioned near the substrate inlet 205 to apply a controlled electrical potential to the substrate 204 as the substrate 204 enters the deposition chamber 112. A grounded roller 208 may be shown at an entry region where the substrate 204 first contacts a grounding element to stabilize the electrical state of the substrate 204 before electrostatic conditioning.

As the substrate 204 travels through the deposition chamber 212, powder particles may be deposited onto the substrate surface, forming the powdered substrate 207. The venting system 210 may be located at an upper portion of the deposition chamber 212 and may capture airborne powder particles that have not deposited on the substrate 204. The recirculated powder particles 224 may be transported from the venting system 210 through the recirculation loop 225, which may direct the recirculated powder particles 224 back to the powder chamber 220.

The powder chamber 220 may serve as both a supply reservoir for fresh powder particles and a receiving vessel for the recirculated powder particles 224. The powder chamber 220 may include a stirring mechanism to fluidize powder materials and maintain uniform powder consistency within the chamber. In some cases, the powder chamber 220 may incorporate conveying and dosing pressure controls to regulate powder feed rate into the deposition chamber 212, allowing precise control over powder concentration and deposition thickness.

After being coated with powder within deposition chamber 112, the powdered substrate 207 may exit the bipolar electrostatic deposition system 200 through the substrate outlet 206 located at an upper portion of the apparatus. The top view perspective of FIG. 3 may demonstrate the horizontal relationship among the substrate transport line, powder delivery and suspension region, and the closed-loop powder recirculation pathway formed by the recirculation loop 225 connecting the venting system 210 to the powder chamber 220.

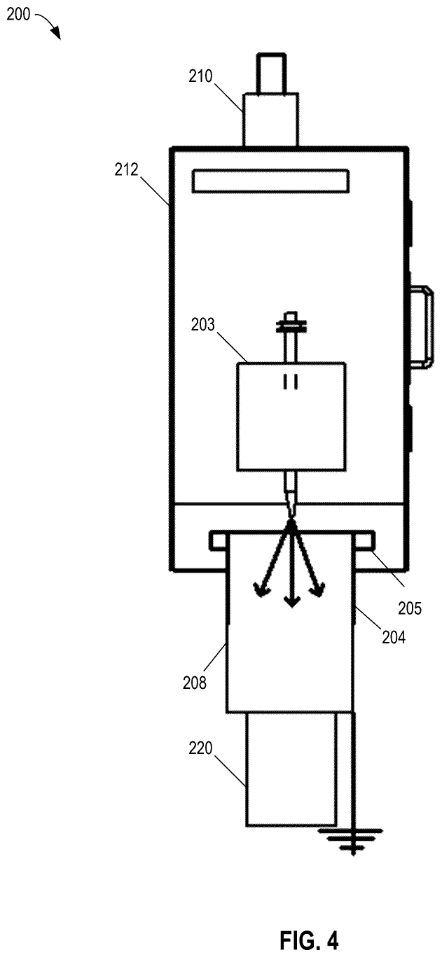

In FIG. 4, a side elevation view of a bipolar electrostatic deposition system 200 illustrates the vertical structural relationship between the powder chamber 220, electrostatic charging components, and the deposition chamber 212. The side view perspective may demonstrate how the various functional elements are arranged vertically to facilitate controlled powder deposition and recirculation within the apparatus.

At a bottom portion of the bipolar electrostatic deposition system 200, the substrate 204 may enter through the substrate inlet 205, initially contacting the grounded roller 208 which may neutralize surface charge and stabilize the electrical state of the substrate 204. The grounded roller 208 may provide a controlled electrical reference point that prepares the substrate 204 for subsequent electrostatic conditioning operations.

Positioned above and/or proximate to the grounded roller 208, the electrostatic generator 203 may be arranged to apply a controlled electric potential or polarity to the substrate 204 prior to entry into the deposition chamber 112. The electrostatic generator 203 may utilize various charging methods to establish the desired electrical conditions on the substrate surface. In some cases, the substrate 204 may be charged through direct electrical contact, where the electrostatic generator 203 makes physical contact with the substrate surface to transfer charge directly. The substrate 204 may also be charged through induction-based charging, where the electrostatic generator 203 creates an electric field that induces charge separation on the substrate surface without direct contact. In some cases, corona-based charging may be employed, where the electrostatic generator 203 generates a corona discharge that deposits charge onto the substrate 204.

The electrostatic generator 203 may provide specific voltage parameters to achieve controlled electrostatic conditions during the deposition process. In some embodiments, the electrostatic generator 203 may provide approximately minus ten kilovolts with controlled current level for experimental conditions. Notably, the controlled current level may allow precise regulation of the charge density applied to the substrate 204, enabling optimization of powder attraction and adhesion characteristics during deposition.

The substrate 204 may then ascend into inlet 205 of the deposition chamber 212, which may contain an impeller-driven turbulent mixing environment to maintain powder in a floating, suspended state. The deposition chamber 212 may be configured to generate either a cyclone pattern that circulates powder along vertical walls and/or a vortex pattern that concentrates powder toward a centerline, depending on airflow conditions supplied through internal gas nozzles and impeller devices

At a top portion of the deposition chamber 212, the venting system 210 may capture micron-scale airborne powder and transfer the powder through a recirculation line that returns the collected powder back into the powder chamber 220. The powder chamber 220 may serve both as an initial supply for powder injections and as a receiving reservoir for recirculated powder. This vertical arrangement may ensure that powder remains in a continuous closed loop, supporting stable long-duration coating operations.

The vertical alignment of the substrate inlet 205, electrostatic conditioning area, the deposition chamber 212, and upper recirculation system of FIG. 4 may illustrate a three-dimensional structure that enables uniform powder attachment to the substrate 204 surface within the bipolar electrostatic deposition system 200. The side view perspective of FIG. 4 may highlight how the vertical spacing between components allows for controlled substrate transport while maintaining proper electrostatic field conditions and powder circulation patterns throughout the deposition process.

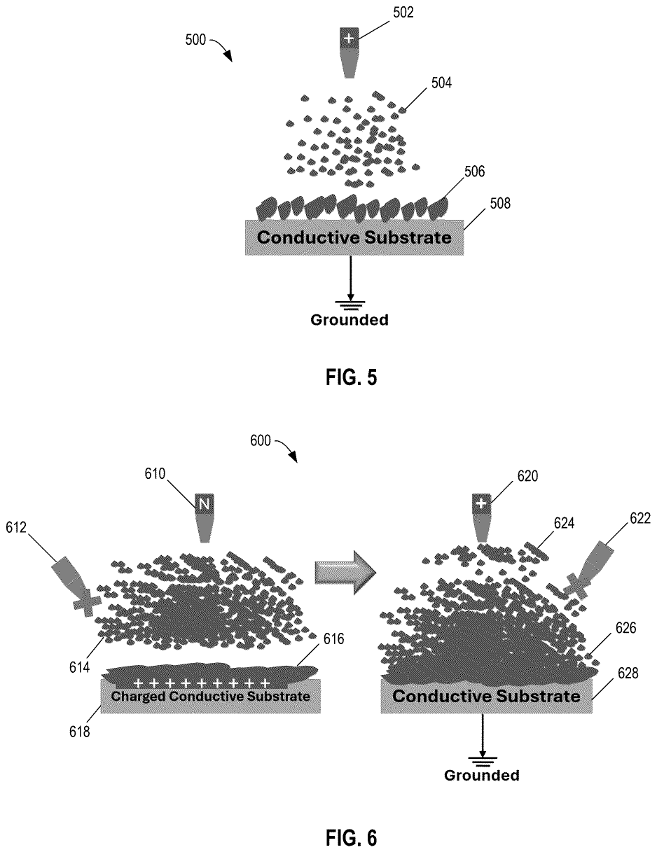

Referring to FIG. 5 and FIG. 6, a comparison between a conventional electrostatic deposition method and the bipolar electrostatic deposition approach may illustrate differences in particle charging mechanisms, electric field structures, and achievable coating characteristics. The comparison may demonstrate how the bipolar approach addresses limitations associated with conventional unipolar deposition systems.

For example, an electrostatic deposition system 500 of FIG. 5 may represent a conventional approach where an electrostatic powder supply unit 502 directs positively charged dispersed particles 504 toward a conductive substrate 508. Notably, in the electrostatic deposition system 500, the dispersed particles 504 may carry a single polarity charge and migrate toward the conductive substrate 508 under the influence of a unipolar electric field. The dispersed particles 504 may accumulate on the conductive substrate 508 to form a deposited layer 506.

The conventional electrostatic deposition system 500 may experience limitations as the deposited layer 506 accumulates on the conductive substrate 508. As the deposited layer 506 builds up, the layer may become charged and begin to shield the underlying electric field. This field shielding effect may weaken the electrostatic attraction near the substrate surface and cause the charged deposited layer 506 to repel additional incoming dispersed particles 504. In some cases, these limitations may restrict the maximum achievable coating thickness and reduce uniformity when attempting multi-layer accumulation.

In contrast, a dual sequencing BED system 600 of FIG. 6 may implement the bipolar electrostatic deposition approach through a two-stage process that addresses the limitations of conventional methods. The dual sequencing BED system 600 may utilize controlled polarity switching and sequential charging operations to achieve enhanced powder adhesion and coating density.

In the first stage of the dual sequencing BED system 600, a powder supply unit 610 may deliver neutralized or grounded powder particles 614 toward a charged conductive substrate 618 while at least one gas nozzle and impeller device 612 generates controlled flow patterns. The charged conductive substrate 618 may be maintained at a predetermined electrical potential that creates an electric field extending into the surrounding region. Notably, the powder particles 614 may be introduced in a neutral state and may experience induced dipole formation when exposed to the electric field of the charged conductive substrate 618. The powder particles 614 may form a positive powder layer 616 on the charged conductive substrate 618 through these induced dipole interactions, which may provide stronger bonding compared to simple electrostatic attraction.

In a second stage of the dual sequencing BED 600, a powder supply unit 620 (i.e., unit 610 may be activated to apply a positive charge and may be represented as unit 620) may direct positively charged powder particles 624 toward a grounded conductive substrate 628 (i.e., charged substrate 618 may be grounded and represented as grounded substrate 628) while at least one gas nozzle and impeller device 622 maintains flow control. The charged powder particles 624 may carry a predetermined polarity and may be attracted to the grounded conductive substrate 628 through conventional electrostatic forces. The charged powder particles 624 may deposit to form a dense coating layer 626 on the grounded conductive substrate 628.

The dual sequencing BED system 600 may achieve higher packing density in the dense coating layer 626 compared to the deposited layer 506 of the conventional electrostatic deposition system 500. The bipolar approach may enable the formation of thicker coatings while maintaining uniformity by avoiding the field collapse issues that limit conventional techniques. In some cases, the combination of dipole interactions and controlled field gradients in the dual sequencing BED system 600 may produce stronger bonding between particles and the substrate surface.

In some embodiments, the electrostatic generator 203 may provide various polarity switching modes to optimize the deposition process for different applications. In some cases, the electrostatic generator 203 may apply positive potential to the substrate 204, creating conditions where neutral or grounded powder particles are attracted to the substrate surface.

In some embodiments, the electrostatic generator 203 may implement alternating polarity during deposition, where the electrical potential applied to the substrate 204 switches between positive and neutral values at predetermined intervals. This alternating polarity approach may help prevent charge buildup on the deposited powder layer and may maintain consistent electrostatic attraction throughout the coating process. In some cases, the electrostatic generator 203 may utilize sequential polarity switching during deposition, where specific polarity sequences are applied to achieve targeted coating characteristics or to accommodate different types of powder materials.

The deposition process may be repeated under reversed substrate polarity or reversed particle polarity (e.g., change of polarity of powder via nozzle 214) to increase packing density and fill voids in the coating layer. In some cases, polarity reversal steps may be implemented where the electrical conditions are inverted between deposition cycles. For example, a substrate that was initially charged to a positive potential (e.g., ‘stage 1’) may be switched to a neutral/grounded potential in a subsequent deposition step (e.g., ‘stage 2’), while the powder charging conditions may be adjusted accordingly. These polarity reversal steps may allow charged particles to be attracted into void spaces within a previously deposited layer, thereby increasing the overall packing density and improving the mechanical properties of the coating. In some embodiments, the bipolar electrostatic deposition process may form binder-free coatings that achieve strong adhesion through bipolar electrostatic attraction and induced dipole interactions, eliminating the need for liquid binders during the deposition process while maintaining excellent particle-to-substrate bonding.

The bipolar electrostatic deposition approach may provide enhanced control over coating thickness, density, and uniformity compared to conventional unipolar methods. The ability to modulate electric field polarity, magnitude, and timing may permit formation of both thin seed layers and thick multi-layer coatings without experiencing the field shielding effects that limit conventional electrostatic deposition techniques. In some cases, the bipolar approach may enable the formation of binder-free coatings with improved adhesion characteristics suitable for advanced battery electrode applications.

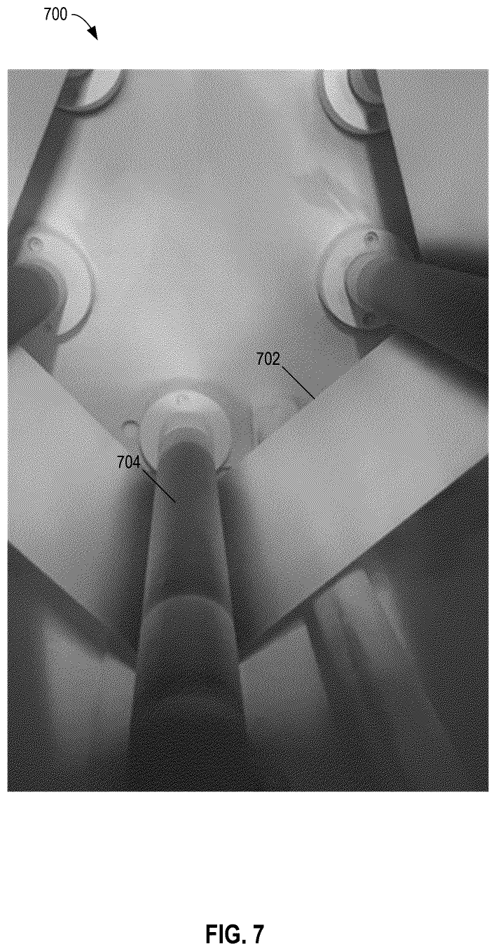

FIG. 7 depicts an image of the interior of an exemplary deposition chamber 700 of the bipolar electrostatic deposition system configured for controlled powder coating operations. In FIG. 7, the deposition chamber 700 may contain a uniformly powdered substrate 702 positioned within the chamber interior, demonstrating the result of the bipolar electrostatic deposition process. The uniformly powdered substrate 702 may exhibit a coating of particulate material distributed across the substrate surface, showing uniform powder distribution achieved through the controlled cyclone and vortex flow patterns within the deposition chamber 700.

A plurality of chamber rollers 704 may be located within the deposition chamber 700 and positioned on top of (or beneath) the uniformly powdered substrate 702. The chamber roller(s) 704 may provide support and guidance for the substrate as the substrate travels through the deposition chamber 700 during the coating process. The chamber roller(s) 704 may maintain the substrate along a defined transport path, ensuring consistent positioning relative to suspended powder particles and electrostatic field conditions within the deposition chamber 700.

The side view perspective of FIG. 7 may reveal the vertical arrangement of components within the deposition chamber 700, showing the spatial relationship between the uniformly powdered substrate 702 and the chamber roller(s) 704. The deposition chamber 700 may enclose the substrate transport path and maintain the controlled environment for electrostatic powder deposition. In some embodiments, the chamber roller(s) 704 may be electrically grounded or maintained at a controlled potential to provide additional electrostatic field control during the deposition process.

After the powder deposition process is completed within the deposition chamber 700, the uniformly powdered substrate 702 may undergo post-deposition processing to consolidate and stabilize the deposited powder layer (as shown in FIG. 1). The post-deposition processing may include a compacting and/or smoothing roll section that consolidates the powder into a uniform coating layer. In some cases, the compacting roll section may apply controlled pressure to the uniformly powdered substrate 702 to increase packing density and improve mechanical adhesion between powder particles and the substrate surface.

The compacting or smoothing roller section may adjust the thickness of the deposited powder layer and/or the substrate itself and may eliminate surface irregularities that could affect the performance of the coated substrate in battery electrode applications. In some cases, the compacting process may be performed at ambient temperature for powder materials that do not require thermal activation. The compacting or smoothing roller section may also be operated at elevated temperatures when the powder materials include thermoplastic binders or other components that benefit from heat treatment during consolidation.

The post-deposition processing may produce a mechanically stable electrode structure with controlled porosity and surface morphology suitable for electrochemical applications. In some cases, the compacting or smoothing roll section may be adjustable to accommodate different powder types and coating thickness requirements. The consolidation process may enhance the electrical conductivity between powder particles and may improve the interfacial contact between the coating layer and the underlying substrate material.

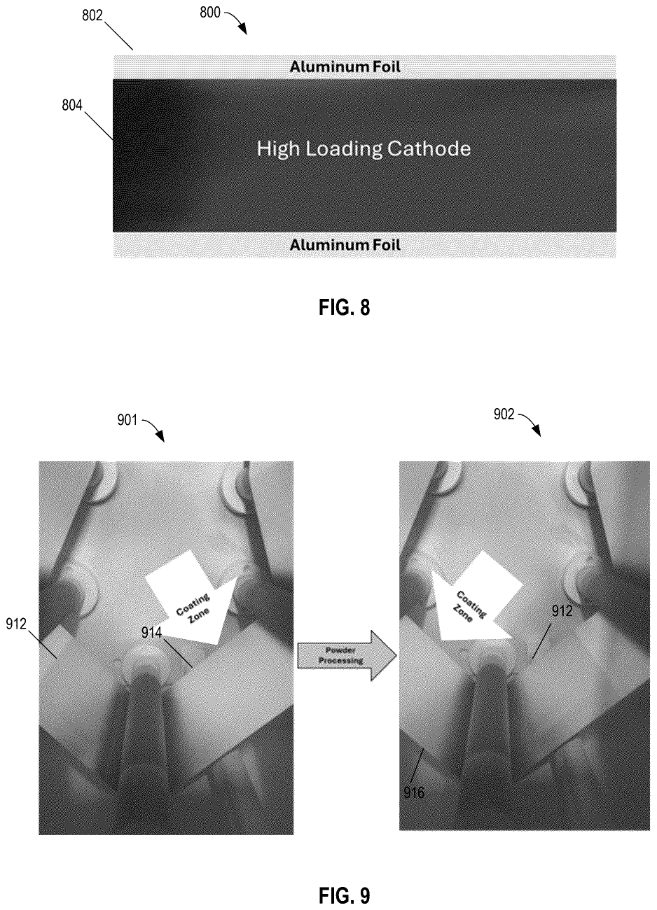

Referring to FIG. 8, the bipolar electrostatic deposition system may be configured to produce high-density electrode structures suitable for advanced battery applications. As shown in FIG. 8, a cathode 800 may be formed through the bipolar electrostatic deposition process, comprising an aluminum foil layer 802 and a high loading cathode layer 804. The high loading cathode layer 804 may be positioned between sections of the aluminum foil layer 802, forming a dense and uniform powder layer that demonstrates the capability of the bipolar electrostatic deposition system to achieve significantly increased active material loading compared to conventional slurry-based coating methods. Because the powder particles are delivered in a dry state and suspended within a controlled cyclone and vortex environment of the deposition chamber prior to deposition, particle packing density may be optimized, allowing the formation of thick cathode layers without cracking, binder migration, or solvent-related defects that may occur in conventional wet coating processes. The bipolar electrostatic field applied during deposition may enhance particle adhesion between the powder materials and the aluminum foil layer 802, enabling strong interfacial bonding even before optional post-processing steps such as PTFE-assisted binder integration, heat rolling, or mechanical compression. The uniform appearance of the high loading cathode layer 804 may highlight the effectiveness of the impeller-driven suspension environment in maintaining consistent powder distribution across the substrate width during the coating process. The deposition thickness of the high loading cathode layer 804 may be precisely controlled by adjusting exposure time, powder concentration, electrostatic field strength, and cyclone vortex flow profile parameters, thereby supporting a wide range of cathode specifications for both conventional and high-energy battery designs. FIG. 8 therefore demonstrates the final product achievable through the BED system—namely, a densely packed, uniform, and mechanically stable cathode layer on aluminum foil—showing that the process is suitable for producing high-performance cathodes with enhanced loading capability and improved interfacial adhesion.

The high loading cathode layer 804 may be deposited onto the aluminum foil layer 802 while the powder particles are maintained in a dry state and suspended within the controlled cyclone and vortex environment of the deposition chamber. The particle packing density of the high loading cathode layer 804 may be optimized through the bipolar electrostatic field interactions, allowing formation of thick cathode layers without cracking, binder migration, or solvent-related defects that may occur in conventional wet coating processes.

The bipolar electrostatic field applied during deposition may enhance particle adhesion between the powder materials and the aluminum foil layer 802, enabling strong interfacial bonding even before optional post-processing steps. The uniform appearance of the high loading cathode layer 804 may highlight the effectiveness of the impeller-driven suspension environment in maintaining consistent powder distribution across the substrate width during the coating process.

The deposition thickness of the high loading cathode layer 804 may be precisely controlled by adjusting exposure time, powder concentration, electrostatic field strength, and cyclone vortex flow profile parameters. In some cases, the bipolar electrostatic deposition system may support a wide range of cathode specifications for both conventional and high-energy battery designs by modulating these process parameters.

FIG. 9 may provide selective coating capabilities for targeted powder deposition applications. The system may demonstrate dual operational modes that enable both uniform full-surface coating and localized deposition depending on the specific electrode requirements. Referring to FIG. 9, deposition images 901 and 902 may illustrate the selective coating capability of the bipolar electrostatic deposition system through controlled flow pattern modulation. The deposition images 901 and 902 may show how the system can direct powder toward specific regions of a substrate while leaving other areas uncoated, demonstrating precise spatial control over the deposition process.

The deposition image 901 may include an uncoated region 912 that remains free of deposited powder particles and a first coating zone 914. Image 902 shows a second coating zone 906 and uncoated region 912. The comparison between different deposition images 901 and 902 may demonstrate how controlled cyclone and vortex flow within the deposition chamber can redirect powder concentration toward desired areas of the substrate surface after a substrate travels within the deposition chamber via chamber rollers.

In some cases, the first coating zone 914 may be located on one side of the substrate, while the second coating zone 916 may appear on a different side following powder processing. This spatial variation may illustrate the system's capability to achieve selective coating by adjusting internal flow patterns via impeller configurations (e.g., rotational speed, blade configuration, direction, etc.) within the deposition chamber. Notably, the gas nozzles and impeller may control the direction and rotational strength of the internal flow patterns, allowing powder to be guided preferentially toward the desired coating zones while maintaining the uncoated region 902 free of deposited particles.

In some embodiments, the deposition chamber may operate in a fully mixed mode that equalizes particulate concentration throughout the chamber volume, providing uniform coating across the entire substrate surface. In the fully mixed mode, the impeller-driven cyclone and vortex flow may produce uniform spatial distribution of powder throughout the deposition chamber, creating conditions suitable for full-surface coating and high-throughput production operations.

Likewise, the deposition chamber may also operate in a selective coating mode where flow patterns are adjusted so that powder is directed preferentially toward specific regions of the substrate. In the selective coating mode, the cyclone and vortex configurations may be modulated to concentrate powder materials in localized regions while leaving other areas uncoated. This selective coating capability may be useful for fabricating electrodes with segmented functional areas or for applying protective layers only to specific portions of composite electrode structures.

The bipolar electrostatic deposition system may accommodate optional binder processing steps when polymer binders are incorporated into the powder formulation. In some cases, the system may include heat rolling or compression processing when PTFE binder is present to enhance adhesion between particles and the substrate surface. The heat rolling process may be performed at elevated temperatures that activate the PTFE binder, promoting bonding between powder particles and improving the mechanical stability of the deposited coating layer.

In some embodiments, the compacting or compression processing may apply controlled pressure to the deposited powder layer, increasing packing density and eliminating void spaces within the coating structure. When PTFE binder is present in the powder formulation, the compression processing may be combined with heat treatment to achieve optimal binder activation and particle-to-substrate adhesion. In some cases, the heat rolling or compression processing may be performed as a continuous operation following the powder deposition step, allowing integrated processing of the coated substrate without intermediate handling steps.

In some embodiments, the optional binder processing may enhance the electrochemical performance and mechanical durability of the cathode 800 by improving interfacial contact between the high loading cathode layer 804 and the aluminum foil layer 802. The processing conditions, including temperature, pressure, and duration, may be adjusted based on the specific binder type and powder characteristics to achieve optimal coating properties for battery electrode applications.

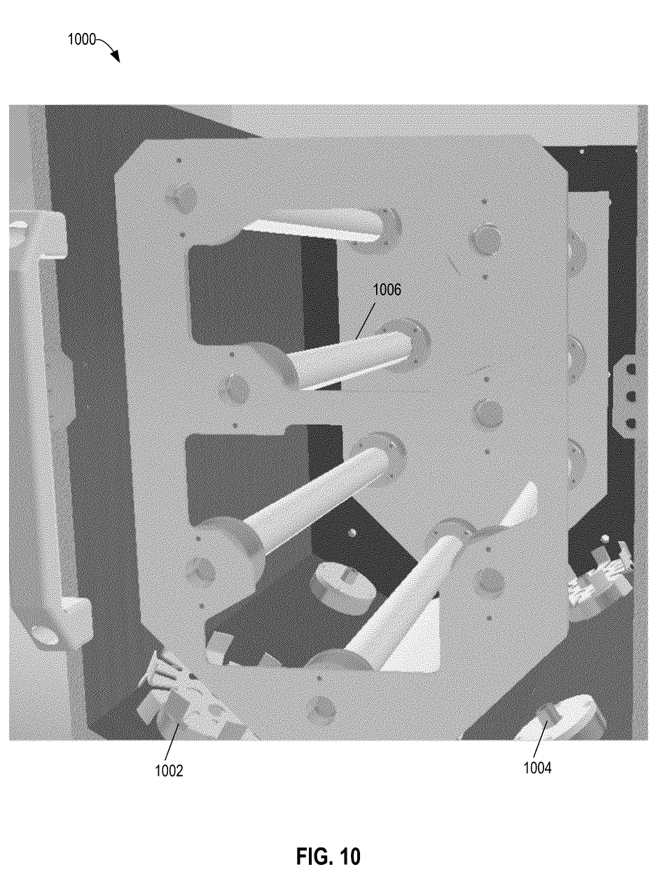

Referring to FIG. 10, a deposition chamber 1000 may illustrate an internal view showing the arrangement of components that generate and control cyclone and vortex flow patterns within the bipolar electrostatic deposition system. The deposition chamber 1000 of FIG. 10 is depicted in a cutaway perspective view, revealing the internal structure and spatial relationships between flow generation components and substrate transport mechanisms.

The deposition chamber 1000 may contain multiple impeller devices 1002 positioned within the chamber volume. An impeller device 1002 may include segmented blades configured to convert incoming airflow into rotational motion. The segmented blades of the impeller device 1002 may be arranged radially around a central hub, with each blade segment designed to interact with upward or angled gas flow to produce controlled rotational patterns. The segmented blade design may allow the impeller 1002 to convert upward airflow into rotational motion that expands or contracts according to the direction of rotation.

When the impeller device 1002 rotates in a first direction, the segmented blades may direct airflow outward toward the walls of the deposition chamber 1000, creating an expanding rotational motion pattern. When the impeller device 1002 rotates in an opposite direction, the segmented blades may direct airflow inward toward the center of the deposition chamber 1000, creating a contracting rotational motion pattern. This dual rotational capability may enable the impeller device 1002 to generate different flow patterns depending on operational requirements.

Multiple gas nozzles 1004 may be distributed around a lower portion of the deposition chamber 1000. A gas nozzle 1004 may introduce directed gas streams into the chamber, providing upward or angled airflow that interacts with the impellers 1002 to generate desired flow patterns. The gas nozzles 1004 may be arranged at strategic locations to optimize powder suspension and circulation throughout the chamber volume. Further, the specific air flow pattern may be generated based on the number of impellers, the rotational speed of the impellers, and the direction of the impellers and/or gas nozzles. In some embodiments, the gas nozzles 1004 may be standalone components or may be integrated with the impeller devices 1002.

The gas nozzles 1004 and/or impellers 1002 may be positioned near lower corners of the deposition chamber 1000 and may be configured to generate either cyclone type rotational flow along the chamber wall or vortex type converging flow toward the center. When the gas nozzles 1004 direct airflow toward the chamber walls, the impeller devices 1002 may amplify this outward motion to create cyclone type rotational flow that circulates powder particles along the perimeter of the deposition chamber 1000. When the gas nozzles 1004 direct airflow toward the chamber center, the impeller devices 1002 may enhance the converging motion to create vortex type flow that concentrates powder particles toward the centerline of the deposition chamber 1000.

In some embodiments, the cyclone type rotational flow may promote complete spatial distribution of powder particles across the deposition chamber 1000 and may be suitable for uniform full-surface coating applications. The vortex type converging flow may enable precise control of powder delivery to be localized areas, resulting in selective deposition and adjustable coating density based on substrate residence time during passage through the deposition chamber 1000.

In some embodiments, the chamber rollers 1006 may be positioned within the deposition chamber 1000 to guide and support the substrate as the substrate travels through the deposition region. A chamber roller 1006 may maintain the substrate along a defined transport path, ensuring consistent positioning relative to suspended powder particles and electrostatic field conditions. The arrangement of the chamber rollers 1006 may allow the substrate to pass through a central region of the deposition chamber 1000 where powder concentration and electrostatic conditions are optimized for uniform deposition.

The internal view of FIG. 10 may demonstrate how the impellers 1002, the gas nozzles 1004, and the chamber rollers 1006 are integrated within the deposition chamber 1000 to create a controlled environment for powder suspension, circulation, and deposition. The gas nozzles 1004 may supply airflow that is converted by the impellers 1002 into rotational patterns, while the chamber rollers 1006 may ensure stable substrate transport through the powder-laden environment.

The deposition chamber 1000 may be configured to operate in either a fully mixed mode for uniform coating across an entire substrate surface or in a selective mode where flow patterns direct powder toward specific regions of the substrate. The impellers 1002 may be controlled through adjustment of rotational speed, blade geometry, and rotational direction to achieve the desired flow characteristics. The gas nozzles 1004 may be controlled through adjustment of gas flow rate, injection angle, and pressure to optimize powder suspension and transport within the deposition chamber 1000.

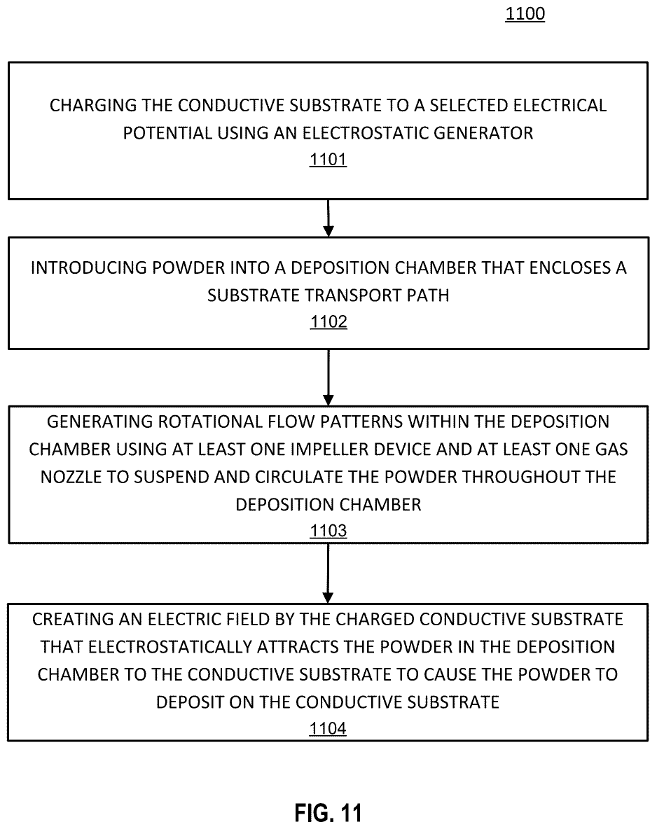

Referring to FIG. 11, a flowchart depicts a process 1500 for forming a particulate coating on a conductive substrate using bipolar electrostatic deposition, according to aspects of the present disclosure. The flowchart illustrates four sequential steps that correspond to the method steps of the bipolar electrostatic deposition process. A first step 1501 represents charging the conductive substrate to a selected electrical potential using an electrostatic generator. A second step 1502 represents introducing powder into a deposition chamber that encloses a substrate transport path. A third step 1503 represents generating rotational flow patterns within the deposition chamber using at least one impeller and at least one gas nozzle to suspend and circulate the powder throughout the deposition chamber. A fourth step 1504 represents creating a bipolar electric field by the charged conductive substrate that electrostatically attracts the powder in the deposition chamber to the conductive substrate to cause the powder to deposit on the conductive substrate. Notably, step 1504 can occur at any time during the process and may occur simultaneously with step 1501, as the bipolar electric field is created when the conductive substrate is charged. In some embodiments, the process may further include a venting step where unused powder is collected by a venting system and returned to a powder reservoir, creating a closed-loop recirculation system that minimizes powder waste and maintains consistent powder concentration during extended coating operations. In some embodiments, the process may further include a compaction step where the deposited powder is compacted using a compacting roller to consolidate the deposited powder and increase packing density, thereby producing a uniform and mechanically stable electrode structure.

A number of implementations have been described. Nevertheless, it will be understood that various modifications may be made without departing from the spirit and scope of the disclosure. Accordingly, other implementations are within the scope of the following claims.

1. A bipolar electrostatic deposition system, comprising:
a deposition chamber configured to enclose a substrate transport path;
an electrostatic generator configured to apply a controlled electrical potential to a conductive substrate;
a powder supply unit configured to supply powder into the deposition chamber;
at least one impeller device and at least one gas nozzle positioned within the deposition chamber and configured to generate rotational flow patterns that suspend and circulate the powder throughout the deposition chamber; and
wherein the electrostatic generator charges the conductive substrate to create an electric field that electrostatically attracts the powder in the deposition chamber to the conductive substrate.

2. The bipolar electrostatic deposition system of claim 1, further comprising a venting system configured to collect unused powder and return the unused powder to a powder reservoir.

3. The bipolar electrostatic deposition system of claim 1, wherein the conductive substrate comprises lithium metal foil, aluminum foil, copper foil, carbon coated foil, nickel foil, stainless steel foil, or graphene-based foil.

4. The bipolar electrostatic deposition system of claim 1, wherein the electrostatic generator is configured to apply a positive potential, a grounded potential, alternating polarity, or sequential polarity switching to the conductive substrate.

5. The bipolar electrostatic deposition system of claim 4, wherein the electrostatic generator provides approximately minus ten kilovolts with a controlled current level.

6. The bipolar electrostatic deposition system of claim 1, wherein at least one impeller device includes segmented blades configured to convert upward airflow into rotational motion that expands or contracts according to a direction of rotation.

7. The bipolar electrostatic deposition system of claim 1, wherein the rotational flow patterns comprise cyclone-type flow along chamber walls or vortex-type flow toward a chamber center.

8. The bipolar electrostatic deposition system of claim 1, wherein the deposition chamber is operable in a fully mixed mode that equalizes powder concentration throughout the deposition chamber.

9. The bipolar electrostatic deposition system of claim 1, wherein the deposition chamber is operable in a selective coating mode where the rotational flow patterns concentrate the powder in localized regions of the conductive substrate.

10. The bipolar electrostatic deposition system of claim 1, further comprising at least one compacting roller positioned downstream of the deposition chamber and configured to compact and consolidate a deposited powder layer on the conductive substrate.

11. A method for forming a particulate coating on a conductive substrate, comprising:
charging the conductive substrate to a selected electrical potential using an electrostatic generator;
introducing powder into a deposition chamber that encloses a substrate transport path;
generating rotational flow patterns within the deposition chamber using at least one impeller device and at least one gas nozzle to suspend and circulate the powder throughout the deposition chamber; and
creating an electric field by the charged conductive substrate that electrostatically attracts the powder in the deposition chamber to the conductive substrate to cause the powder to deposit on the conductive substrate.

12. The method of claim 11, further comprising collecting unused powder and returning the unused powder to a powder reservoir using a venting system.

13. The method of claim 11, further comprising a two-stage deposition process including: a first stage of depositing neutral powder onto the charged conductive substrate through induced dipole interactions, and a second stage of modifying the electrical potential of the conductive substrate and depositing electrostatically charged powder onto the substrate to increase packing density and fill voids in a previously formed coating layer.

14. The method of claim 11, wherein the step of charging the conductive substrate comprises direct electrical contact charging, induction-based charging, or corona-based charging.

15. The method of claim 14, wherein the step of charging the conductive substrate applies approximately minus ten kilovolts with a controlled current level.

16. The method of claim 11, wherein the rotational flow patterns comprise cyclone-type flow along chamber walls or vortex-type flow toward a chamber center.

17. The method of claim 11, further comprises a step of repeating the introducing and creating steps under reversed substrate polarity or reversed particle polarity to increase packing density and fill voids in the coating.

18. The method of claim 11, further comprising a step of compacting the coating using a compacting roller to consolidate the deposited powder and increase packing density.

19. A particulate coated electrode produced by a process comprising:
charging a conductive substrate to a selected electrical potential using an electrostatic generator;
introducing powder into a deposition chamber that encloses a substrate transport path;
generating rotational flow patterns within the deposition chamber using at least one impeller device and at least one gas nozzle to suspend and circulate the powder throughout the deposition chamber; and
creating an electric field by the charged conductive substrate that electrostatically attracts the powder in the deposition chamber to the conductive substrate to cause the powder to deposit on the conductive substrate.

20. The particulate coated electrode of claim 19, wherein the electrode comprises a compacted particulate layer having a controlled density and thickness.
